(19) United States
(12) Patent Application Publication
(10) Pub. No.: US 2024/0310875 A1
(43) Pub. Date: Sep. 19, 2024

(54) PORT REPLICATOR

(71) Applicant: Panasonic Intellectual Property Management Co., Ltd., Osaka (JP)

(72) Inventors: Takanori AOYAGI, Osaka (JP); Takamitsu SUZUKI, Osaka (JP); Satoshi TSUNEMI, Osaka (JP)

(73) Assignee: Panasonic Intellectual Property Management Co., Ltd., Osaka (JP)

(21) Appl. No.: 18/673,399

(22) Filed: May 24, 2024

Related U.S. Application Data
(63) Continuation of application No. PCT/JP2022/039856, filed on Oct. 26, 2022.

(30) Foreign Application Priority Data
Dec. 13, 2021 (JP) 2021-201833

(51) Int. Cl. G06F 1/16

(52) U.S. Cl. CPC G06F 1/1632; G06F 1/1656

(57) ABSTRACT

A port replicator includes: a main body having a placement surface on which an electronic device is placed and an accommodation hole in the placement surface; a pop-up portion accommodated in the accommodation hole and having a support surface that supports the electronic device; and an elastic body that biases the pop-up portion in a direction in which the support surface protrudes from the accommodation hole. The pop-up portion is movable between a first position where the pop-up portion is accommodated in the accommodation hole and a second position where the support surface protrudes from the main body more than the first position, an interference member is provided on at least one of an inner wall of the accommodation hole or an outer wall of the pop-up portion along the inner wall, and the inner wall and the outer wall come into contact with each other via the interference member.

### TECHNICAL FIELD

The present disclosure relates to a port replicator.

### BACKGROUND ART

Patent Literature 1 discloses a docking device that extends functions of a portable information device such as a laptop PC. The docking device of Patent Literature 1 includes an elastic member that biases the bottom surface of the laptop PC.

### CITATION LIST

### Patent Literature

PTL 1: Unexamined Japanese Patent Publication No. 2010-250699

### SUMMARY OF THE INVENTION

In the docking device described in Patent Literature 1, there is still room for improvement in that the device jumps up when the device is removed from the docking device.

The present disclosure provides a port replicator that suppresses jumping up of an electronic device.

A port replicator according to an aspect of the present disclosure is a port replicator on which an electronic device is placed, the port replicator including:
a main body having a placement surface on which the electronic device is placed and an accommodation hole provided in the placement surface;
a pop-up portion accommodated in the accommodation hole and including a support surface that supports the electronic device; and
an elastic body that biases the pop-up portion in a first direction in which the support surface protrudes from the accommodation hole.

The pop-up portion is configured to be movable between a first position where the pop-up portion is accommodated in the accommodation hole and a second position where the support surface protrudes from the main body more than the first position, an interference member is provided on at least one of an inner wall of the accommodation hole or an outer wall of the pop-up portion disposed along the inner wall, and the inner wall and the outer wall come into contact with each other via the interference member while the pop-up portion moves from the first position to the second position.

According to the present disclosure, it is possible to provide a port replicator in which jumping up of an electronic device is suppressed.

### BRIEF DESCRIPTION OF THE DRAWINGS

FIG. 1 is a perspective view illustrating a port replicator according to a first exemplary embodiment of the present disclosure.

FIG. 2 is a perspective view illustrating an example in which an electronic device is placed on the port replicator of FIG. 1.

FIG. 3 is a side view of the port replicator of FIG. 1.

FIG. 4 is an enlarged view of a region R1 in FIG. 1.

FIG. 5 is a cross-sectional view taken along line A-A of FIG. 4.

FIG. 6 is a view illustrating a state in which a pop-up portion of FIG. 4 is taken out from an accommodation hole.

FIG. 7 is a view of the pop-up portion of FIG. 6 as viewed from another angle.

FIG. 8 is a partial cross-sectional view taken along line B-B in FIG. 4 and illustrating a state in which the pop-up portion is located at a first position.

FIG. 9 is a partial cross-sectional view taken along line B-B in FIG. 4 and illustrating a state in which the pop-up portion is located between the first position and a second position.

FIG. 10 is a partial cross-sectional view taken along line B-B in FIG. 4 and illustrating a state in which the pop-up portion is located between the first position and the second position.

FIG. 11 is a partial cross-sectional view taken along line B-B in FIG. 4 and illustrating a state in which the pop-up portion is located at the second position.

FIG. 12 is a perspective view illustrating a pop-up portion of a port replicator according to a first modification of the first exemplary embodiment.

FIG. 13 is a perspective view of the pop-up portion of the port replicator of FIG. 12 as viewed from another direction.

FIG. 14 is a cross-sectional view illustrating a pop-up portion of a port replicator according to a second modification of the first exemplary embodiment.

FIG. 15 is a cross-sectional view illustrating a pop-up portion of a port replicator according to a third modification of the first exemplary embodiment.

### DESCRIPTION OF EMBODIMENT

### Background to the Present Invention

A docking device called a port replicator that can be connected to an electronic device such as a laptop PC or a tablet PC to expand an input and output terminal and the like is known. For example, the docking device described in Patent Literature 1 extends the function of the laptop PC by placing the laptop PC on the upper surface thereof and connecting the laptop PC.

The docking device described in Patent Literature 1 includes a support member arranged to be vertically movable via an elastic member, and is configured to support a portable information device by biasing a bottom surface of the portable information device with the support member.

On the other hand, there is a demand for connecting a plurality of electronic devices having different sizes to one port replicator. When a plurality of electronic devices are connected, the biasing force of the elastic member is set according to the electronic device having the largest weight. In this case, there is a problem that the biasing force of the elastic member becomes excessive in a case where an electronic device having a smaller weight is connected, and the electronic device jumps when the electronic device is removed from the port replicator. In other words, there is a problem that the electronic device is biased by the elastic member when the electronic device is removed from the port replicator, and the electronic device bounces.

The present inventors have studied a port replicator capable of suppressing jumping up of an electronic device, and have reached the following invention.

A port replicator according to a first aspect of the present disclosure is a port replicator on which an electronic device is placed, the port replicator including:
a main body having a placement surface on which the electronic device is placed and an accommodation hole provided in the placement surface;
a pop-up portion accommodated in the accommodation hole and having a support surface that supports the electronic device; and
an elastic body that biases the pop-up portion in a first direction in which the support surface protrudes from the accommodation hole,
in which the pop-up portion is arranged to be movable between a first position where the pop-up portion is accommodated in the accommodation hole and a second position where the support surface protrudes from the main body more than the first position,
an interference member is provided on at least one of an inner wall of the accommodation hole or an outer wall of the pop-up portion disposed along the inner wall, and
the inner wall and the outer wall come into contact with each other via the interference member while the pop-up portion moves from the first position to the second position.

With such a configuration, it is possible to provide a port replicator capable of suppressing jumping up of an electronic device.

In a port replicator according to a second aspect of the present disclosure,
the interference member may include at least one of: a first protrusion provided on the inner wall and protruding in a second direction toward the outer wall, a cross section of the first protrusion when cut along a plane intersecting the second direction becoming smaller toward the second direction; or a second protrusion provided on the outer wall and protruding in a third direction toward the inner wall, a cross section of the second protrusion when cut along a plane intersecting the third direction becoming smaller toward the third direction.

With such a configuration, the pop-up portion can be smoothly moved.

In a port replicator according to a third aspect of the present disclosure,
the first protrusion or the second protrusion may be formed in a tapered shape.

With such a configuration, the pop-up portion can be smoothly moved.

In a port replicator according to a fourth aspect of the present disclosure,
the first protrusion or the second protrusion may be formed in a curved shape.

With such a configuration, the pop-up portion can be smoothly moved.

In a port replicator according to a fifth aspect of the present disclosure,
the interference member may include both the first protrusion and the second protrusion, the second protrusion may be located below the first protrusion when the pop-up portion is located at the first position, and the second protrusion may be located above the first protrusion when the pop-up portion is located at the second position.

With such a configuration, in a case where the pop-up portion is at the first position and in a case where the pop-up portion is at the second position, the interference member does not interfere with each other, and thus, it is possible to easily attach the electronic device to the port replicator. In addition, since the load on the interference member is reduced, durability can be improved.

In a port replicator according to a sixth aspect of the present disclosure,
at least one of the first protrusion or the second protrusion may include a plurality of protrusions.

With such a configuration, a space in which the interference member is disposed can be reduced, and thus a degree of freedom in designing the main body and the pop-up portion is improved.

In a port replicator according to a seventh aspect of the present disclosure,
the plurality of protrusions may be arranged side by side in a direction intersecting the first direction.

With such a configuration, since the size of the region to be interfered can be adjusted, the moving speed of the pop-up portion when moving from the first position to the second position can be controlled. Therefore, it is possible to more effectively suppress the jumping up of the electronic device.

In a port replicator according to an eighth aspect of the present disclosure,
the plurality of protrusions may be arranged side by side along the first direction.

With such a configuration, since the size of the region to be interfered can be adjusted, the moving speed of the pop-up portion when moving from the first position to the second position can be controlled. Therefore, it is possible to more effectively suppress the jumping up of the electronic device.

In a port replicator according to a ninth aspect of the present disclosure,
the plurality of protrusions may be provided at each of both ends in a direction intersecting a moving direction of the pop-up portion.

With such a configuration, it is possible to prevent the inclination of the pop-up portion.

In a port replicator according to a tenth aspect of the present disclosure,
the interference member may include at least one of a first resin sheet disposed on the inner wall or a second resin sheet disposed on the outer wall.

With such a configuration, it is possible to provide a port replicator capable of suppressing the jumping up of the electronic device while reducing the manufacturing cost.

### First Exemplary Embodiment

### [Overall Configuration]

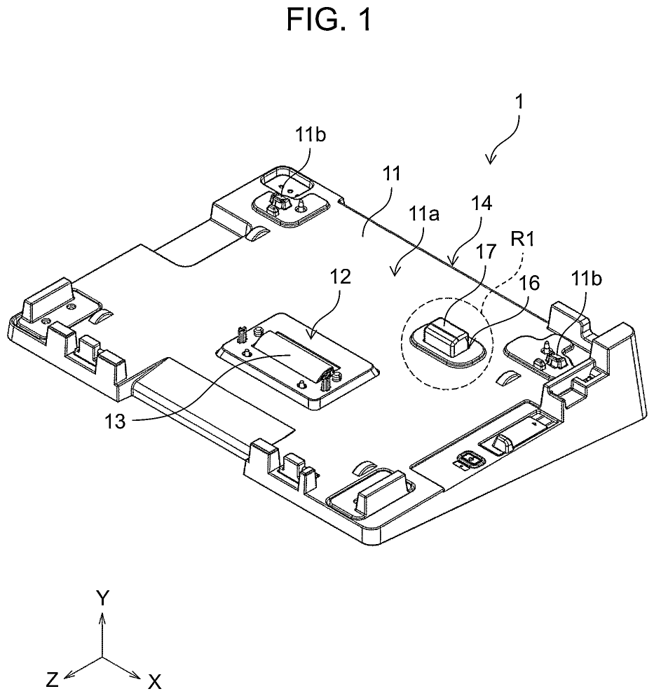

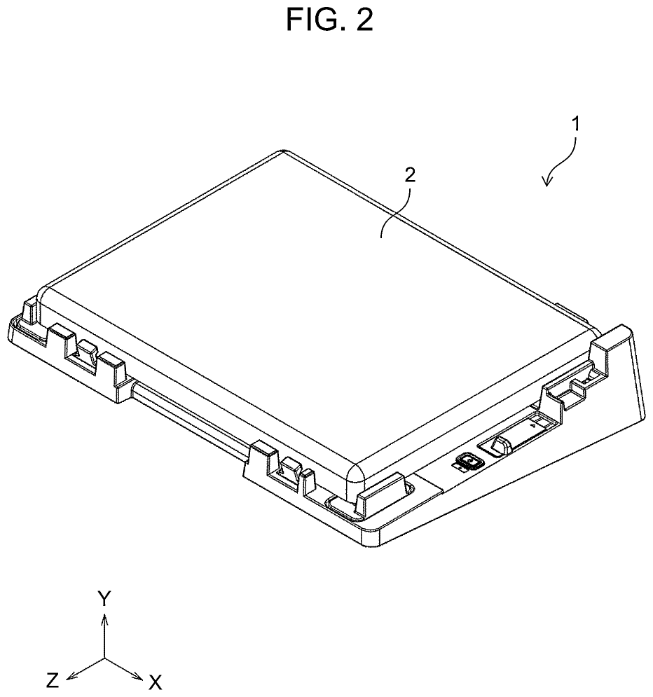

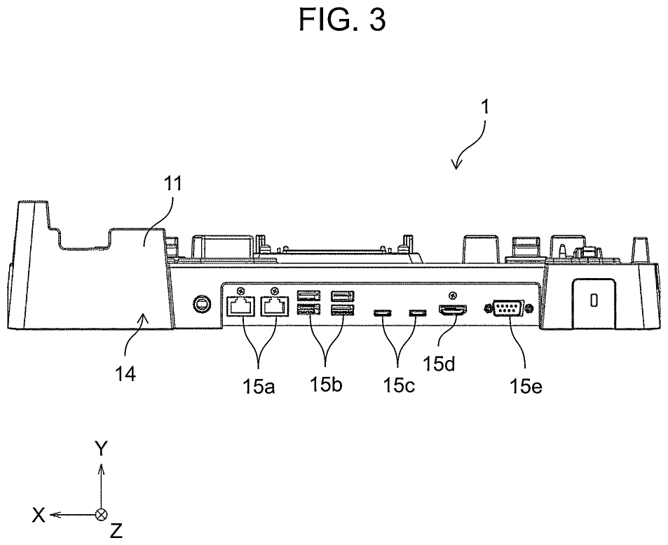

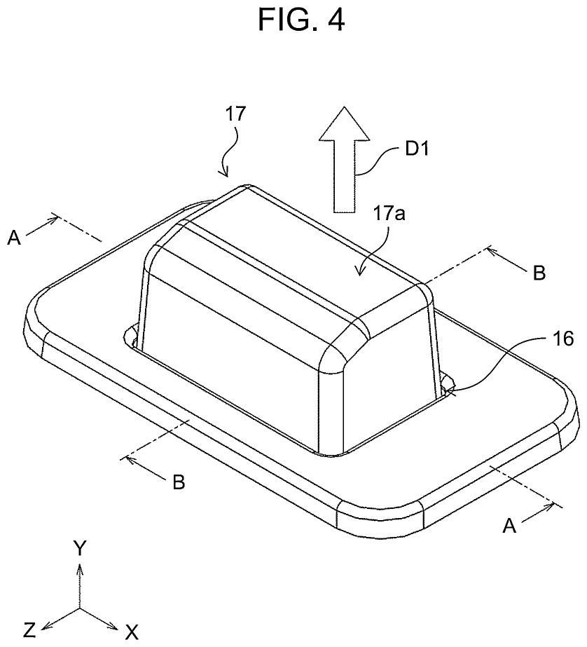

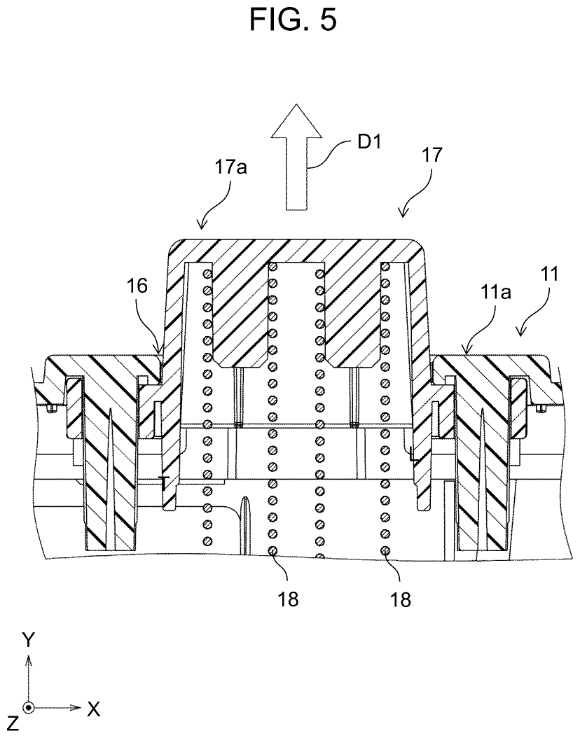

FIG. 1 is a perspective view of port replicator 1 according to a first exemplary embodiment of the present disclosure. FIG. 2 is a perspective view illustrating an example in which electronic device 2 is placed on port replicator 1 of FIG. 1. FIG. 3 is a side view of port replicator 1 of FIG. 1. FIG. 4 is an enlarged view of region R1 in FIG. 1. FIG. 5 is a cross-sectional view taken along line A-A of FIG. 4. In the following description, the X direction in each drawing may be referred to as a width direction, the Y direction may be referred to as a thickness direction, and the Z direction may be referred to as a depth direction.

As illustrated in FIGS. 1 to 5, port replicator 1 includes main body 11, pop-up portion 17, and elastic member 18.

Port replicator 1 is a device that expands the function of electronic device 2 such as a laptop PC or a tablet PC. For example, when electronic device 2 is connected to port replicator 1 as illustrated in FIG. 2, additional input and output ports 15a to 15e (see FIG. 3) can be used in addition to the input and output ports mounted on electronic device 2. Note that, in the present specification, connecting port replicator 1 and electronic device 2 indicates that port replicator 1 and electronic device 2 are electrically connected via connector 12 to be described later.

### <Main Body>

Electronic device 2 such as a laptop PC or a tablet PC is placed on main body 11 of port replicator 1. In the present exemplary embodiment, main body 11 is formed in a rectangular shape in plan view, and includes placement surface 11a on which electronic device 2 is placed. Main body 11 can be formed of, for example, resin.

As illustrated in FIG. 1, placement surface 11a is inclined such that the height decreases toward the front side of port replicator 1, for example. By disposing placement surface 11a in an inclined manner, usability when electronic device 2 is placed on port replicator 1 is improved. The front side of port replicator 1 refers to a portion of port replicator 1 facing the +Z direction in FIG. 1.

Port replicator 1 and electronic device 2 are fixed by, for example, engagement portion 11b (see FIG. 1). Specifically, engagement portion 11b is disposed on placement surface 11a of port replicator 1. Electronic device 2 can be fixed to port replicator 1 by engaging the engaging portion 11b with a recess (not illustrated) provided in the bottom surface of electronic device 2. Engagement portion 11b can be configured by, for example, a hook or the like.

Connector 12 for electrically connecting port replicator 1 and electronic device 2 is disposed on placement surface 11a of main body 11. By connecting connector 12 to a connector (not illustrated) provided in electronic device 2, port replicator 1 and electronic device 2 can be electrically connected. In the present exemplary embodiment, when electronic device 2 is not connected to the connector, cover 13 is disposed on connector 12 to cover the terminal of connector 12. When electronic device 2 is connected to the connector, cover 13 is open. Cover 13 is not an essential component.

As illustrated in FIG. 3, various input and output ports are arranged on side surface 14 of main body 11. The input and output port is an insertion port of a cable, a connector, or the like. In the present exemplary embodiment, for example, LAN port 15a, USB-A port 15b, USB-C port 15c, HDMI (registered trademark) port 15d, and serial port 15e are arranged on side surface 14 of port replicator 1. The type and the number of ports arranged in port replicator 1 are not limited thereto, and may be more or less than the example shown in FIG. 3.

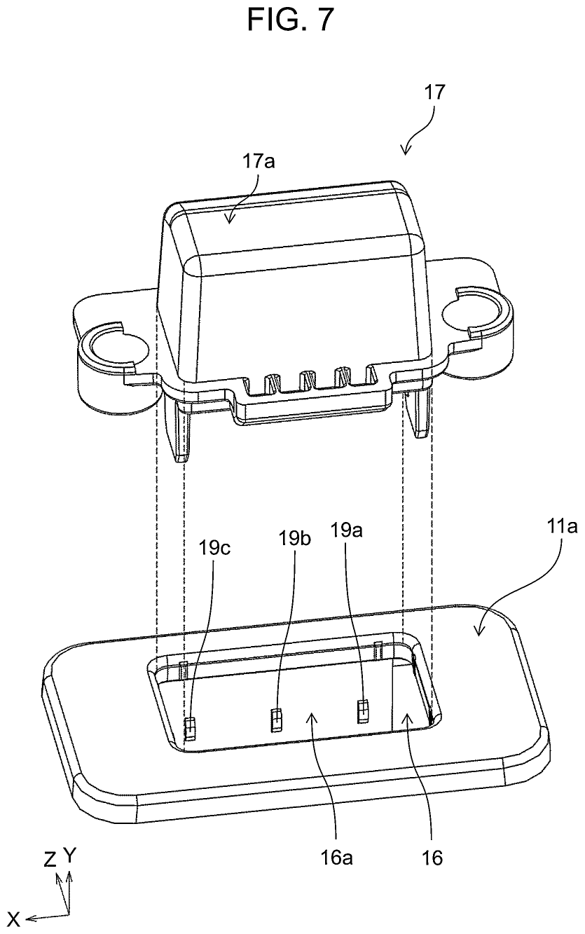

Accommodation hole 16 is provided in placement surface 11a of main body 11. Pop-up portion 17 to be described later is accommodated in accommodation hole 16. As illustrated in FIG. 7 to be described later, accommodation hole 16 is defined by inner wall 16a. Three first protrusions 19a to 19c are formed on inner wall 16a. In the present exemplary embodiment, first protrusions 19a to 19c are arranged in a line in the X direction. In other words, first protrusions 19a to 19c are arranged side by side in a direction intersecting first direction D1 (see FIG. 4) to be described later. First protrusions 19a to 19c are formed so as to protrude in a second direction (−Z direction) toward outer wall 17b of pop-up portion 17 described later. First protrusions 19a to 19c correspond to interference members that interfere with outer wall 17b of pop-up portion 17.

### <Pop-Up Portion>

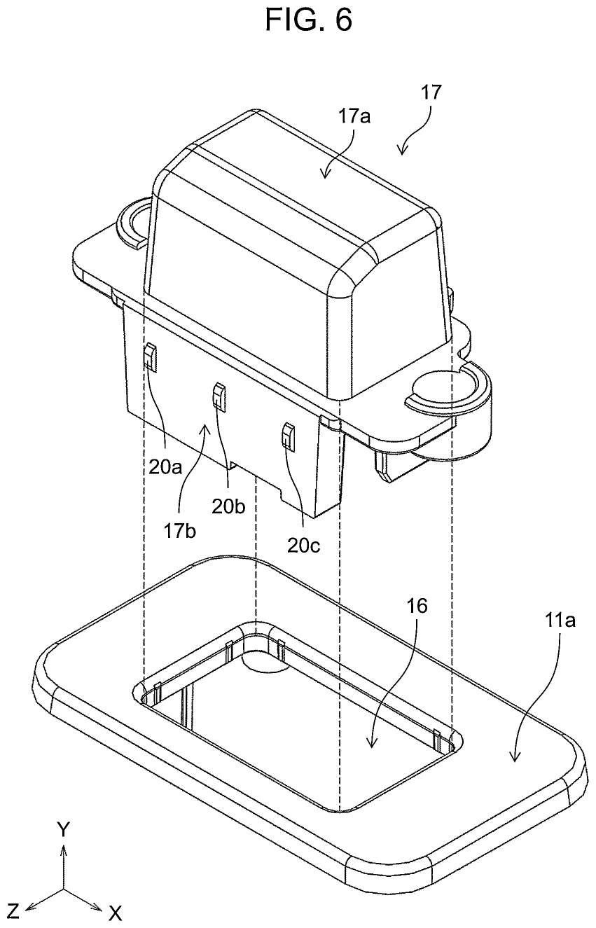

FIG. 6 is a view illustrating a state where pop-up portion 17 in FIG. 4 is taken out from accommodation hole 16. FIG. 7 is a view of pop-up portion 17 in FIG. 6 as viewed from another angle.

Pop-up portion 17 is a member formed in a columnar shape, and can move in the vertical direction (Y direction) from accommodation hole 16. In the present exemplary embodiment, pop-up portion 17 is formed in a rectangular shape in plan view. Pop-up portion 17 is a component for releasing the connection between electronic device 2 and port replicator 1.

As illustrated in FIG. 4, pop-up portion 17 is accommodated in accommodation hole 16 of main body 11 and has support surface 17a that supports electronic device 2. When electronic device 2 is connected to port replicator 1, support surface 17a comes into contact with the bottom surface of electronic device 2. Pop-up portion 17 is biased in first direction D1 (+Y direction) in which support surface 17a protrudes from accommodation hole 16 by elastic member 18 illustrated in FIG. 5.

As illustrated in FIGS. 6 to 7, pop-up portion 17 has outer wall 17b disposed along inner wall 16a of accommodation hole 16. Three second protrusions 20a to 20c are formed on outer wall 17b. Second protrusions 20a to 20c are formed to protrude in the third direction (+Z direction) from outer wall 17b of pop-up portion 17 toward inner wall 16a of accommodation hole 16. In the present exemplary embodiment, second protrusions 20a to 20c are arranged in a line in the X direction. That is, second protrusions 20a to 20c are arranged side by side in a direction intersecting first direction D1. Second protrusions 20a to 20c correspond to interference members that interfere with inner wall 16a of accommodation hole 16.

### <Elastic Member>

Elastic member 18 biases pop-up portion 17 in the first direction. As illustrated in FIG. 5, elastic member 18 is formed of, for example, a member having an elastic force such as a coil spring. When the engagement of engagement portion 11b with electronic device 2 is released, pop-up portion 17 lifts electronic device 2 by the biasing force of elastic member 18, and the connection between the connector of electronic device 2 and connector 12 of port replicator 1 can be released.

### [Operation of Pop-Up Portion]

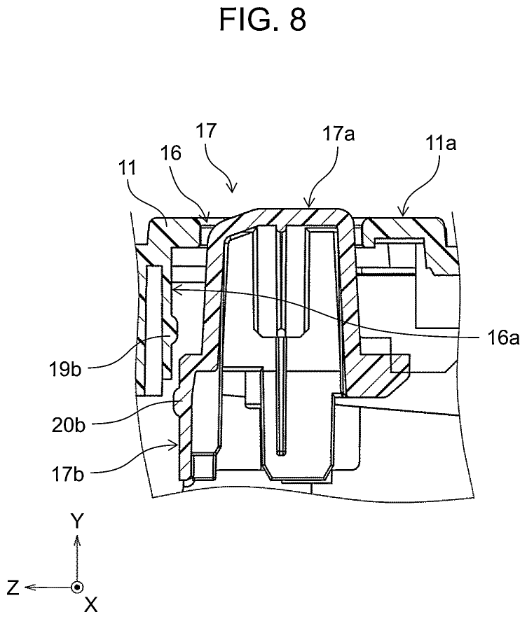

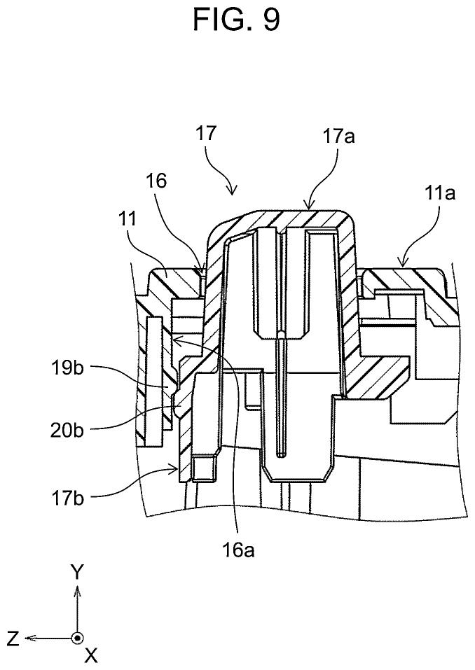

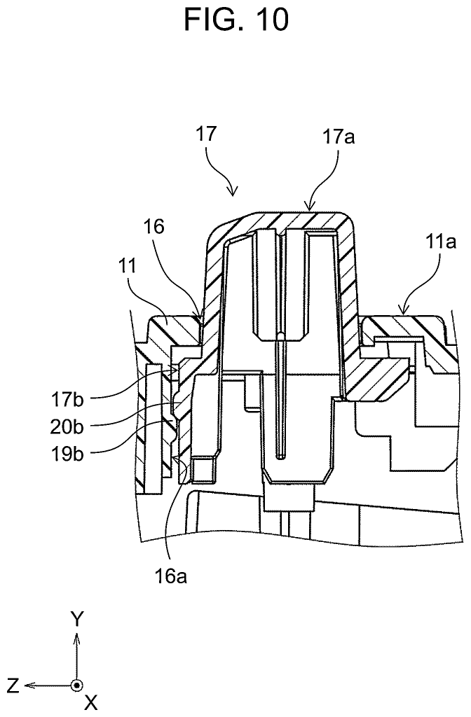

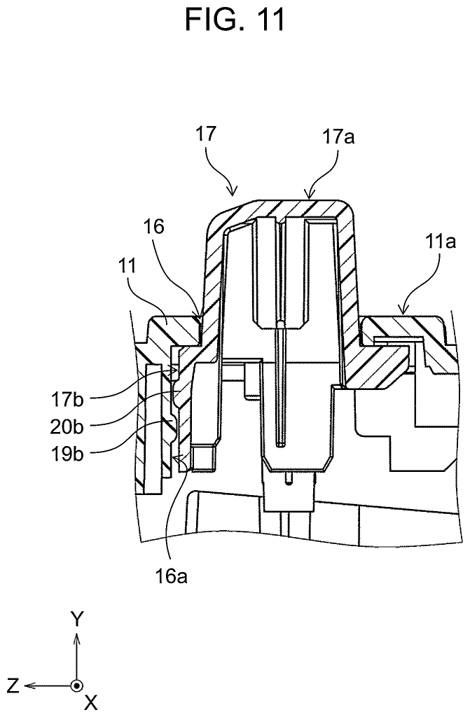

FIG. 8 is a partial cross-sectional view taken along line B-B in FIG. 4 and illustrating a state in which pop-up portion 17 is located at the first position. FIGS. 9 and 10 are partial cross-sectional views taken along line B-B in FIG. 4 and illustrating a state in which pop-up portion 17 is located between the first position and the second position. FIG. 11 is a partial cross-sectional view taken along line B-B in FIG. 4 and illustrating a state in which pop-up portion 17 is located at the second position. An example of the operation of pop-up portion 17 will be described with reference to FIGS. 8 to 11.

Pop-up portion 17 is disposed to be movable between a first position where the pop-up portion 17 is accommodated in accommodation hole 16 illustrated in FIG. 8 and a second position where support surface 17a protrudes from main body 11 more than the first position illustrated in FIG. 11. When electronic device 2 is not connected to port replicator 1, pop-up portion 17 is located at the second position illustrated in FIG. 11 by the biasing force of elastic member 18. When electronic device 2 is connected to port replicator 1, pop-up portion 17 is pushed into accommodation hole 16 by the bottom surface of electronic device 2. Therefore, when electronic device 2 is connected to port replicator 1, pop-up portion 17 is located at the first position.

When the engagement between engagement portion 11b of port replicator 1 and electronic device 2 is released, pop-up portion 17 is lifted in first direction D1 by the biasing force of elastic member 18. Pop-up portion 17 moves in first direction D1, and first protrusion 19b provided on inner wall 16a of accommodation hole 16 and second protrusion 20b of outer wall 17b of pop-up portion 17 come into contact with each other. Similarly, first protrusion 19a and second protrusion 20a are in contact with each other, and first protrusion 19c and second protrusion 20c are in contact with each other. That is, while pop-up portion 17 moves from the first position to the second position, inner wall 16a and outer wall 17b come into contact with each other via the interference members (first protrusions 19a to 19c and second protrusions 20a to 20c).

When pop-up portion 17 further moves in first direction D1 after first protrusions 19a to 19c and second protrusions 20a to 20c come into contact with each other, first protrusions 19a to 19c and second protrusions 20a to 20c interfere with each other. Therefore, the speed at which pop-up portion 17 moves in first direction D1 is reduced by friction between first protrusions 19a to 19c and second protrusions 20a to 20c. When pop-up portion 17 further moves in first direction D1, as illustrated in FIG. 10, first protrusions 19a to 19c and second protrusions 20a to 20c do not interfere with each other. Pop-up portion 17 further moves, and the movement of pop-up portion 17 stops at the second position as illustrated in FIG. 11.

First protrusions 19a to 19c and second protrusions 20a to 20c interfere with each other, so that the moving speed of pop-up portion 17 is reduced, and thus, it is possible to suppress the jumping up of electronic device 2.

As shown in FIGS. 8 to 11, in the present exemplary embodiment, first protrusion 19b is formed so as to become smaller toward the second direction in a cross section taken along a plane (YZ plane) intersecting the second direction (−Z direction). More specifically, first protrusion 19b is formed in a tapered shape in a cross section when cut along the YZ plane. Similarly, first protrusions 19a and 19c are also formed in a tapered shape in the cross section when cut along the YZ plane.

Moreover, in the present exemplary embodiment, second protrusion 20b is formed so as to become smaller toward the third direction in a cross section taken along a plane (YZ plane) intersecting the third direction (+Z direction). More specifically, second protrusion 20b is formed in a tapered shape in a cross section when cut along the YZ plane. Similarly, second protrusions 20a and 20c are also formed in a tapered shape in the cross section when cut along the YZ plane.

Since first protrusions 19a to 19c and second protrusions 20a to 20c are formed in a tapered shape, even when first protrusions 19a to 19c and second protrusions 20a to 20c contact and interfere with each other, pop-up portion 17 can be smoothly moved. Therefore, the impact applied to electronic device 2 is reduced, and electronic device 2 can be prevented from jumping up.

In the present exemplary embodiment, as illustrated in FIG. 8, when pop-up portion 17 is located at the first position, second protrusions 20a to 20c are located below first protrusions 19a to 19c. As illustrated in FIG. 11, when pop-up portion 17 is located at the second position, second protrusions 20a to 20c are located above first protrusions 19a to 19c. That is, when pop-up portion 17 is located at the first position and the second position, the respective protrusions are arranged so that first protrusions 19a to 19c and second protrusions 20a to 20c do not interfere with each other.

### [Effects]

According to the exemplary embodiment described above, it is possible to provide port replicator 1 in which the jumping up of the electronic device is suppressed. When the connection between port replicator 1 and electronic device 2 is released, electronic device 2 is lifted up by pop-up portion 17. Pop-up portion 17 of port replicator 1 is lifted up by elastic member 18 having a predetermined biasing force. Elastic member 18 may have a biasing force enough to lift electronic device 2 by pop-up portion 17 to release the connection with port replicator 1. When port replicator 1 corresponds to a plurality of electronic devices 2 having different weights, the biasing force of elastic member 18 is set to a value corresponding to electronic device 2 having the largest weight.

In the above-described exemplary embodiment, since the interference member is provided on outer wall 17b of pop-up portion 17 and inner wall 16a of accommodation hole 16, friction occurs when pop-up portion 17 moves in first direction D1. Therefore, the speed at which pop-up portion 17 moves in first direction D1 can be reduced. When the moving speed of pop-up portion 17 is reduced, even in a case where electronic device 2 having a smaller weight is connected to port replicator 1, it is possible to prevent electronic device 2 from jumping up by being lifted up by pop-up portion 17 at the time of removal.

In the above-described exemplary embodiment, the example in which the protrusions as the interference members are formed on both inner wall 16a of accommodation hole 16 and outer wall 17b of pop-up portion 17 has been described, but the present invention is not limited thereto. The interference member may be formed on at least one of inner wall 16a of accommodation hole 16 or outer wall 17b of pop-up portion 17.

In addition, in the above-described exemplary embodiment, an example in which first protrusions 19a to 19c and second protrusions 20a to 20c are formed in a tapered shape has been described, but the present invention is not limited thereto. At least one of first protrusions 19a to 19c or second protrusions 20a to 20c may be formed in, for example, a curved surface shape. Alternatively, at least one of first protrusions 19a to 19c or second protrusions 20a to 20c may be formed in a shape in which the tip becomes narrower toward the tip.

In addition, in the above-described exemplary embodiment, an example in which three first protrusions 19a to 19c and three second protrusions 20a to 20c are provided has been described, but the present invention is not limited thereto. The first protrusions and the second protrusions may be constituted by one protrusion or may be constituted by a plurality of protrusions.

In addition, in the above-described exemplary embodiment, an example in which first protrusions 19a to 19c and second protrusions 20a to 20c are arranged side by side in the direction intersecting first direction D1 has been described, but the present invention is not limited thereto. For example, at least one of the first protrusions or the second protrusions may be arranged side by side along first direction D1.

### (Modification)

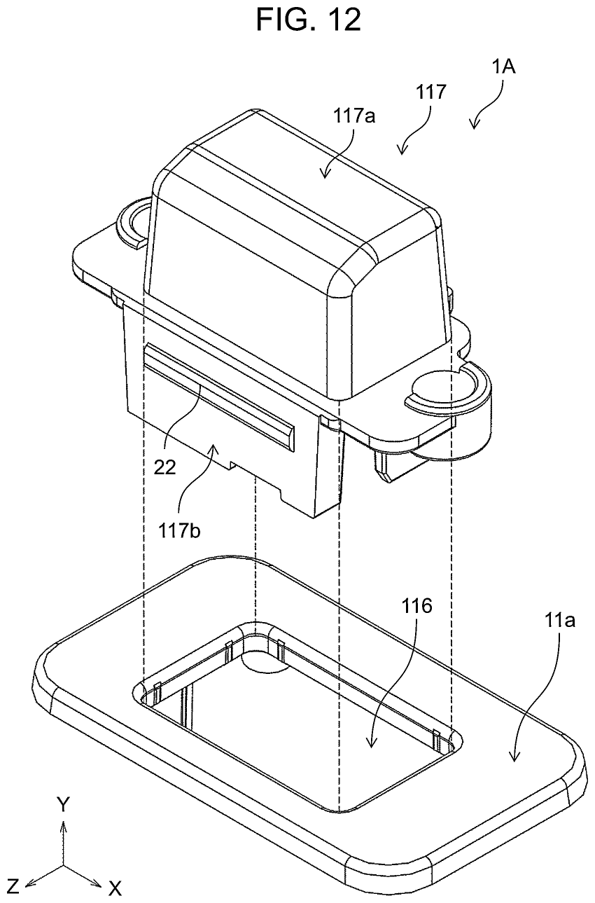

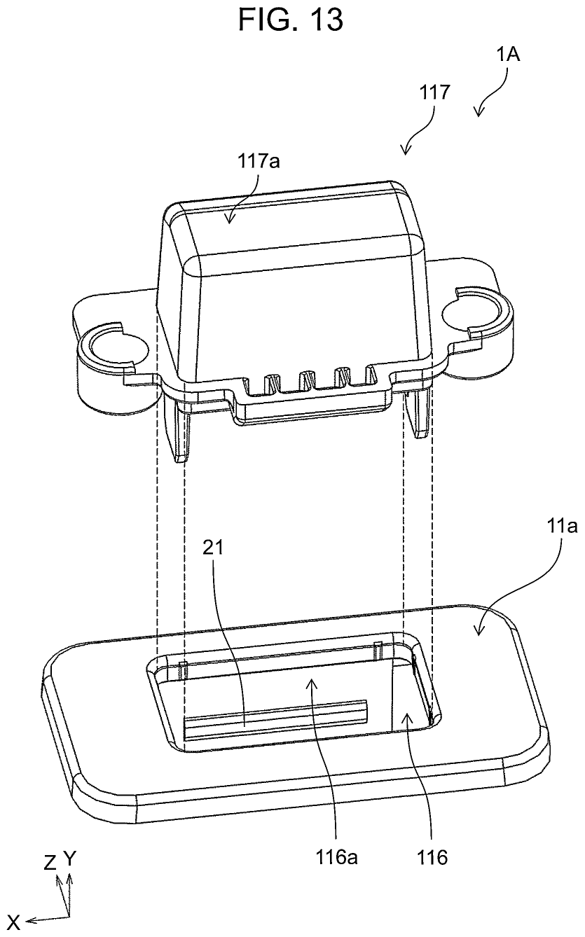

FIG. 12 is a perspective view illustrating pop-up portion 117 of port replicator 1A according to a first modification of the first exemplary embodiment. FIG. 13 is a perspective view of pop-up portion 117 of port replicator 1A of FIG. 12 as viewed from another direction. As illustrated in FIGS. 12 and 13, one protrusion 21 and one protrusion 22 may be formed on inner wall 116a of accommodation hole 116 and outer wall 117b of pop-up portion 117, respectively. In the first modification, rib-shaped first protrusion 21 is formed on inner wall 116a of accommodation hole 116, and rib-shaped second protrusion 22 is formed on outer wall 117b of pop-up portion 117. By changing the widths and sizes of protrusions 21, 22, the area of the interfering portion can be changed, and the moving speed of pop-up portion 117 can be appropriately adjusted.

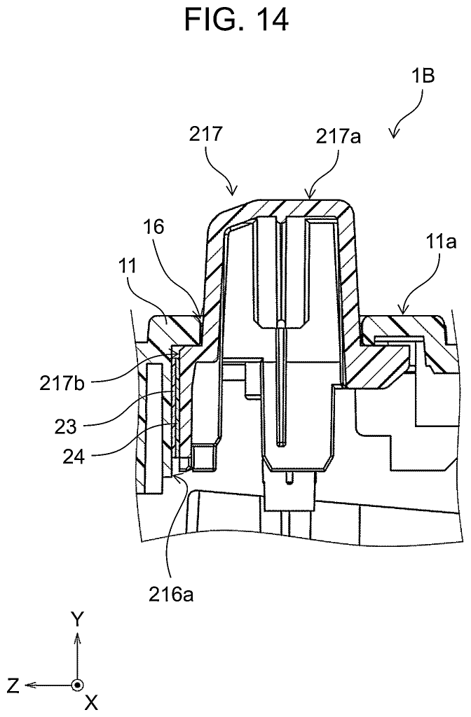

FIG. 14 is a cross-sectional view illustrating pop-up portion 217 of port replicator 1B according to a second modification of the first exemplary embodiment. As illustrated in FIG. 14, in port replicator 1B, first resin sheet 23 is disposed on inner wall 216a of accommodation hole 216, and second resin sheet 24 is disposed on outer wall 217b of pop-up portion 217. In the second modification, first resin sheet 23 and second resin sheet 24 correspond to interference members. First resin sheet 23 and second resin sheet 24 can be formed of a synthetic resin such as polycarbonate. Even in a case where the resin sheet is disposed instead of the protrusion, the moving speed of pop-up portion 117 can be reduced by friction. Further, a resin sheet may be disposed on one of inner wall 216a of accommodation hole 216 and outer wall 217b of pop-up portion 217, and a protrusion may be formed on the other.

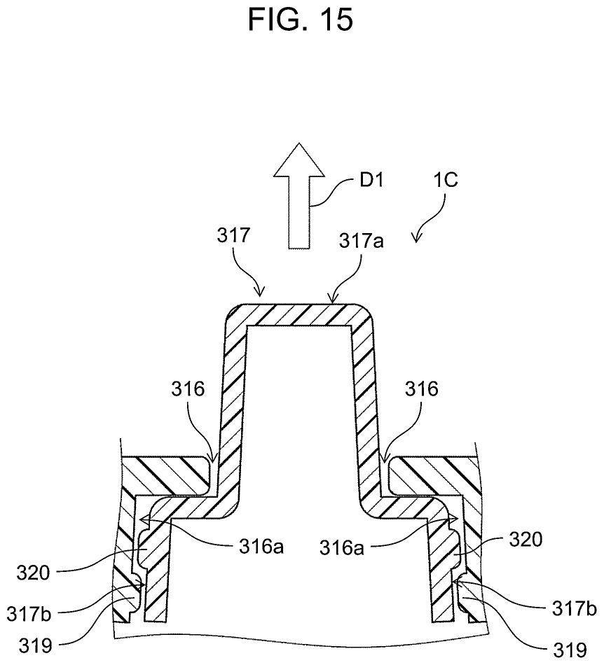

FIG. 15 is a cross-sectional view illustrating pop-up portion 317 of port replicator 1C according to a third modification of the first exemplary embodiment. As illustrated in FIG. 15, first protrusion 319 and second protrusion 320 may be provided at each of two ends (both ends) facing each other in a direction intersecting the moving direction (first direction D1) of pop-up portion 317. That is, in the Z direction intersecting the moving direction (first direction D1) of pop-up portion 317, first protrusions 319 may be formed on inner walls 316a at both ends of accommodation hole 316, and second protrusions 30a may be formed on the outer walls 317b at both ends of the pop-up portion 317.

### INDUSTRIAL APPLICABILITY

The present disclosure can be widely applied to a port replicator to which an electronic device can be connected.

### REFERENCE MARKS IN THE DRAWINGS

1, 1A, 1B, 1C: port replicator
2: electronic device
11: main body
11a: placement surface
16, 116, 216, 316: accommodation hole
16a, 116a, 216a, 316a: inner wall
17, 117, 217, 317: pop-up portion
17a: support surface
17b, 117b, 217b, 317b: outer wall
18: clastic member
19a to 19c, 21: first protrusion
20a to 20c, 22: second protrusion
23: first resin sheet
24: second resin sheet
D1: first direction

1. A port replicator on which an electronic device is placed, the port replicator comprising:
a main body having a placement surface on which the electronic device is placed and an accommodation hole provided in the placement surface;
a pop-up portion accommodated in the accommodation hole and including a support surface that supports the electronic device; and
an elastic body that biases the pop-up portion in a first direction in which the support surface protrudes from the accommodation hole,
wherein the pop-up portion is configured to be movable between a first position where the pop-up portion is accommodated in the accommodation hole and a second position where the support surface protrudes from the main body more than the first position,
an interference member is provided on at least one of an inner wall of the accommodation hole or an outer wall of the pop-up portion disposed along the inner wall, and
the inner wall and the outer wall come into contact with each other via the interference member while the pop-up portion moves from the first position to the second position.

2. The port replicator according to claim 1, wherein the interference member includes at least one of:
a first protrusion provided on the inner wall and protruding in a second direction from the inner wall toward the outer wall, a cross section of the first protrusion when cut along a plane intersecting the second direction becoming smaller toward the second direction; or
a second protrusion provided on the outer wall and protruding in a third direction from the outer wall toward the inner wall, a cross section of the second protrusion when cut along a plane intersecting the third direction becoming smaller toward the third direction.

3. The port replicator according to claim 2, wherein the first protrusion or the second protrusion has a tapered shape.

4. The port replicator according to claim 2, wherein the first protrusion or the second protrusion has a curved surface shape.

5. The port replicator according to claim 2, wherein
the interference member includes both the first protrusion and the second protrusion,
the second protrusion is located below the first protrusion when the pop-up portion is located at the first position, and
the second protrusion is located above the first protrusion when the pop-up portion is located at the second position.

6. The port replicator according to claim 2, wherein at least one of the first protrusion or the second protrusion includes a plurality of protrusions.

7. The port replicator according to claim 6, wherein the plurality of protrusions are arranged in a direction intersecting the first direction.

8. The port replicator according to claim 6, wherein the plurality of protrusions are arranged along the first direction.

9. The port replicator according to claim 6, wherein
the pop-up portion has two ends facing each other in a direction intersecting a moving direction of the pop-up portion, and
the plurality of protrusions are provided at each of the two ends of the pop-up portion.

10. The port replicator according to claim 1, wherein the interference member includes at least one of a first resin sheet disposed on the inner wall or a second resin sheet disposed on the outer wall.

11. The port replicator according to claim 10, wherein the interference member includes both the first resin sheet and the second resin sheet.
